(19) United States
(12) Patent Application Publication
(10) Pub. No.: US 2026/0249181 A1
(43) Pub. Date: Aug. 27, 2026

(54) INFORMATION DISPLAY METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Jing YANG, Shenzhen (CN); Zhiliang ZHEN, Shenzhen (CN)

(21) Appl. No.: 19/641,622

(22) Filed: Apr. 8, 2026

Related U.S. Application Data
(63) Continuation of application No. PCT/CN2025/076688, filed on Feb. 10, 2025.

(30) Foreign Application Priority Data
Feb. 22, 2024 (CN) 202410196713.3

(51) Int. Cl. A63F 13/537; A63F 13/46; A63F 13/533

(52) U.S. Cl. CPC A63F 13/537; A63F 13/46; A63F 13/533

(57) ABSTRACT

An information display method and device. The method includes displaying a video footage of a game match on a video playback interface; displaying win rate change information and at least one event identifier on the video playback interface, the win rate change information reflecting a change trend, over time, of a win rate of at least one team participating in the game match, and the event identifier indicating an event associated with a change in the win rate in the game match; and displaying, in response to an operation for a first event identifier among the at least one event identifier, event prompt information of the first event identifier, the event prompt information of the first event identifier indicating a first event and an impact of the first event on the win rate, and the first event being an event indicated by the first event identifier.

### RELATED APPLICATIONS

This application is a continuation of PCT Application No. PCT/CN2025/076688 filed on February 10, 2025, which in turn claims priority to Chinese Patent Application No. 202410196713.3, entitled "INFORMATION DISPLAY METHOD AND APPARATUS, DEVICE, AND STORAGE MEDIUM" filed on February 22, 2024, which are both incorporated by reference in their entirety.

### FIELD OF THE TECHNOLOGY

Embodiments of this application relate to the field of computer technologies, and in particular, to an information display method and apparatus, a device, and a storage medium.

### BACKGROUND OF THE DISCLOSURE

Game matches constantly change. Win rates of game participants also constantly change. The win rate of a game participant is a probability that the game participant wins in a game match.

A win rate change curve is usually used in a process of playing back a video of the game match, to help a user learn win rate changes of the game participant. The win rate change curve can reflect advantages and disadvantages that are obtained by a group or an individual in the match, and fluctuations of match performance. A viewer can more objectively learn competitiveness and strength between the game participants by viewing the win rate change curve.

However, the win rate change curve can only show changes-over-time of the win rate of the game participant, and information that can be provided by the win rate change curve is limited.

### SUMMARY

The embodiments of this application provide an information display method and apparatus, a device, and a storage medium. The technical solutions provided in the embodiments of this application are as follows:

One aspect of the embodiments of this application provides an information display method. The method is performed by a terminal device and includes displaying a video footage of a game match on a video playback interface; displaying win rate change information and at least one event identifier on the video playback interface, the win rate change information reflecting a change trend, over time, of a win rate of at least one team participating in the game match, and the event identifier indicating an event associated with a change in the win rate in the game match; and displaying, in response to an operation for a first event identifier among the at least one event identifier, event prompt information of the first event identifier, the event prompt information of the first event identifier indicating a first event and an impact of the first event on the win rate, and the first event being an event indicated by the first event identifier.

Another aspect of the embodiments of this application provides a terminal device. The terminal device includes a processor and a memory, the memory having a computer program stored therein, and the computer program being loaded and executed by the processor to implement the foregoing information display method.

Another aspect of the embodiments of this application provides a non-transitory computer-readable storage medium. The computer-readable storage medium has a computer program stored therein, the computer program being loaded and executed by a processor to implement the foregoing information display method.

The technical solutions provided in the embodiments of this application have at least the following beneficial effects:

By displaying the win rate change information and the at least one event identifier on the video playback interface on which the video footage of the game match is displayed, the win rate change information can be configured for reflecting the change trend, over time, of the win rate of the at least one team participating in the game match, and the event identifier can be configured for indicating the event that causes the change in the win rate in the game match. In addition, in response to the operation on the first event identifier among the at least one event identifier, the event prompt information corresponding to the first event identifier is displayed. The event prompt information of the first event identifier is configured for indicating the first event and the impact of the first event on the win rate, and the first event is the event indicated by the first event identifier. This enables the video playback interface to not only indicate the change trend of the win rate, but also indicate the event causing the change in the win rate and the impact of the event on the win rate, so that the video playback interface provides match information more comprehensively. This helps to improve comprehensiveness of obtaining information. Meanwhile, by using the win rate change information and the event identifier, a viewer can learn a winning situation of the game match more comprehensively. This helps enhance the viewing experience.

In addition, the event causing the change in the win rate can be quickly learned by using the event identifier, and the viewer does not need to view, replay, and analyze a video frame by frame, so that the viewer can quickly learn key information of the game match, thus reducing the difficulty level for obtaining match information and improving the convenience for obtaining information.

### BRIEF DESCRIPTION OF THE DRAWINGS

FIG. 1 is a schematic diagram of a solution implementation environment according to an embodiment of this application.

FIG. 2 is a flowchart of an information display method according to an embodiment of this application.

FIG. 3 is a schematic diagram of a video playback interface according to an embodiment of this application.

FIG. 4 is a schematic diagram of a win rate change curve and an event identifier according to an embodiment of this application.

FIG. 5 is a schematic diagram of event prompt information according to an embodiment of this application.

FIG. 6 is a schematic diagram of split-screen displaying on a video playback interface according to an embodiment of this application.

FIG. 7 is a schematic diagram of a win rate update bullet comment displayed on a video live stream interface according to an embodiment of this application.

FIG. 8 is a schematic diagram of a win rate update bullet comment according to an embodiment of this application.

FIG. 9 is a schematic diagram of win rate update bullet comments in different display styles according to an embodiment of this application.

FIG. 10 is a schematic diagram of a first reaction bullet comment and a second reaction bullet comment according to an embodiment of this application.

FIG. 11 is a schematic diagram of a third reaction bullet comment and a fourth reaction bullet comment according to an embodiment of this application.

FIG. 12 is a schematic diagram of a fifth reaction bullet comment and a sixth reaction bullet comment according to an embodiment of this application.

FIG. 13 is a schematic diagram of a reaction bullet comment displayed on a video playback interface according to an embodiment of this application.

FIG. 14 is a schematic diagram of displaying of a change in a win rate update bullet comment according to an embodiment of this application.

FIG. 15 is a schematic diagram of first prompt information according to an embodiment of this application.

FIG. 16 is a schematic diagram of an execution logic of an information display method according to an embodiment of this application.

FIG. 17 is a schematic diagram of a logic of a service side of an information display method according to an embodiment of this application.

FIG. 18 is a block diagram of an information display apparatus according to an embodiment of this application.

FIG. 19 is a block diagram of a structure of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

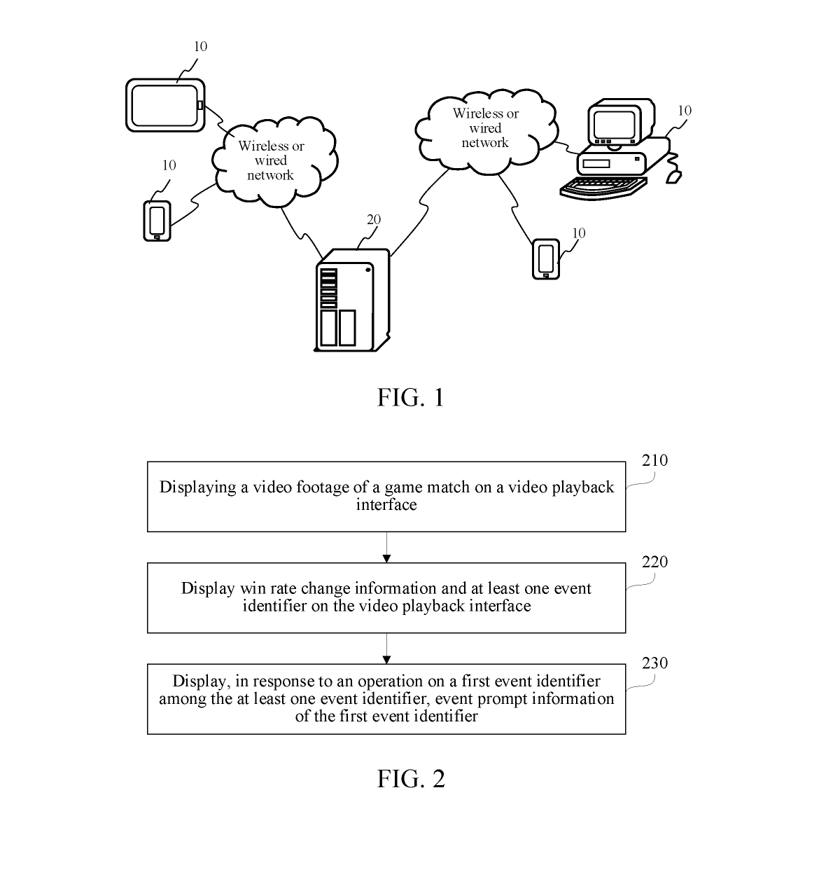

FIG. 1 is a schematic diagram of a solution implementation environment according to an embodiment of this application. The solution implementation environment may include a terminal device 10 and a server 20.

The terminal device 10 may be at least one of electronic devices such as a mobile phone, a tablet computer, a multimedia playback device, a personal computer (PC), a wearable device, an in-vehicle terminal device, an intelligent robot, a virtual reality (VR) device, an augmented reality (AR) device, a mixed reality (MR) device, a moving picture experts group audio layer 3 (MP3) player, and a moving picture experts group audio layer 4 (MP4) player. A client running a target application program may be installed in the terminal device 10. The target application program may be a live stream application program, a video playback application program, a game application program, a socialization and entertainment application program, or any other application program providing a video playback function.

The server 20 may be configured to provide a backend service to a client of the target application program (for example, the live stream application program) in the terminal device 10. For example, the server 20 may be a backend server of the target application program (for example, the live stream application program). The server 20 may be a server, a server cluster including a plurality of servers, or a cloud computing service center.

The terminal device 10 may communicate with the server 20 by using a network, for example, a wired or wireless network.

In addition, in this embodiment of this application, an implementation form of the foregoing target application program is not limited. For example, the target application program may be an application program that needs to be downloaded and installed, a mini program that does not need to be installed, a web application program, or the like.

FIG. 2 shows a flowchart of an information display method according to an embodiment of this application. Operations of the method may be executed by a terminal device, for example, a client of a target application program in the terminal device. The method may include at least one operation of the following operations 210 to 230.

Operation 210: Display a video footage of a game match on a video playback interface.

The video playback interface is an interface configured for presenting the video footage. The game match is a match started by a game application program. The video footage of the game match is a picture captured in the game match and is configured for presenting a game process of the game match. In some embodiments, a client providing the video playback interface and a client providing the game match may be the same client. For example, both of them may be a client of a game application program. The client providing the video playback interface and the client providing the game match may be different clients. For example, the client providing the video playback interface is a client of a live stream application program, and the client providing the game match is the client of the game application program. This is not limited by this embodiment of this application.

In some embodiments, the video playback interface is a live stream interface of a live stream application program. The live stream interface is configured to present the video footage of the game match in real time. In some embodiments, the game match is a game match that is currently being played. For example, the client displays the video footage of the game match at an observer view (OB) on the video playback interface. The OB is a match viewing angle used during live streaming of a game competition. It allows a viewer to watch, in real time in a live stream process of the match, conditions of all venues, teams, and virtual characters controlled by players, and obtain comprehensive and detailed competition data and information. In the game competition, the OB is operated and controlled by a camera operator (referred to as an observer). The camera operator can perform switching based on important moments and key pictures of the competition, to provide a better watching experience for viewers. The OB enables the viewer to watch the match from a neutral perspective, thus not only obtaining an overall strategy progress of the game match, but also obtaining specific tactical execution and details. In addition, the OB helps a commentator or a commentator of the game competition to analyze and interpret the situation.

In some embodiments, the video footage may alternatively be a recorded video footage of the game match. That is, the client displays the recorded video footage of the game match on the video playback interface.

In some embodiments, the game match is a battle of a multiplayer online battle arena (MOBA) game. In such a game, a player usually controls a virtual character referred to as a "hero", forms a team with other players, and cooperatively defeats opponents. A winning condition of the game is usually that a main building of an opponent team is destroyed.

In some embodiments, the game match may alternatively be a shooting game (STG), a real-time strategy (RTS), and any other game match in which a player is determined as a winner or a loser. This is not limited by this embodiment of this application.

The video footage of the game match is configured for presenting in-match content of the game match. For example, the in-match content of the game match may include at least one of the following: an action of a virtual character controlled by a player in the game match, a virtual scene configured for starting the game match, an interaction between the virtual character and the virtual scene, interactions between different virtual characters controlled by different players, a virtual map related to the virtual scene, and other content.

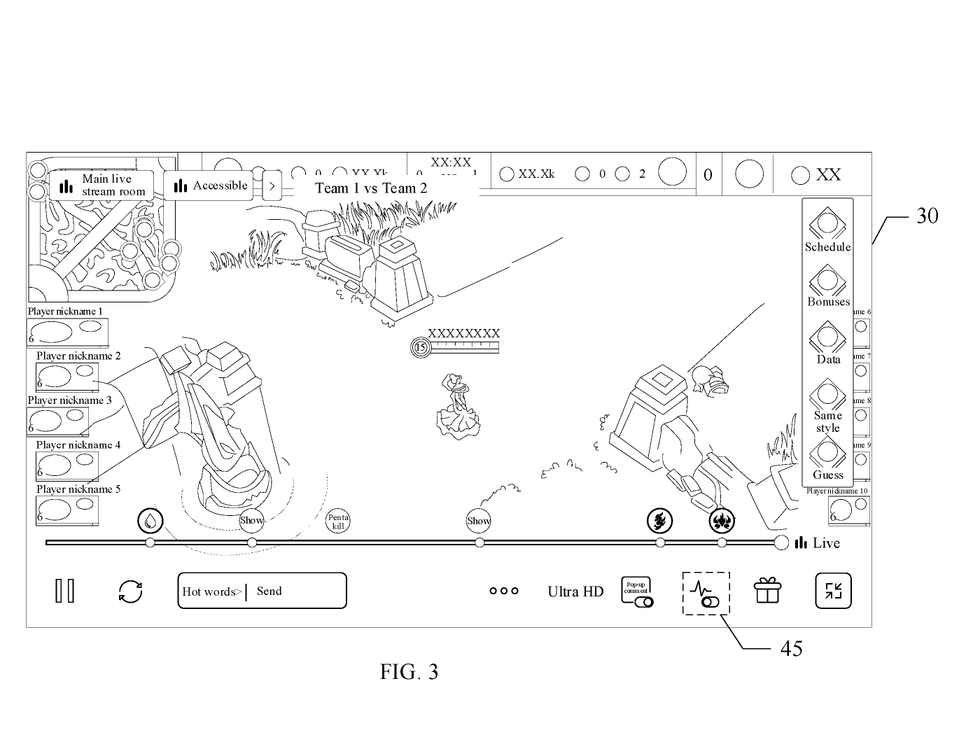

For example, FIG. 3 shows a schematic diagram of a video playback interface according to an embodiment of this application. The video playback interface 30 is a live stream interface. The video playback interface 30 displays a video footage of a game match that is currently being played. The video footage may be configured for presenting in-match content such as interactions between virtual characters and interaction between a virtual character and a virtual environment.

Operation 220: Display win rate change information and at least one event identifier on the video playback interface.

The win rate change information may be configured for reflecting a change trend, over time, of a win rate of at least one team participating in the game match. A win rate of a team participating in the game match refers to a probability that the team wins in the game match. A winning condition of the team in the game match may be that a set target is achieved, for example, a virtual character controlled by a player in another team is defeated, a core structure of another team is destroyed, the virtual character reaches a designated position, or a collected virtual object satisfies a designated condition. This application does not limit winning conditions of teams participating in the game match. In some embodiments, each team may include at least one virtual character. Win rate change information at a current moment may be configured for reflecting a win rate of the at least one team at the current moment and win rates of the at least one team at moments before the current moment.

In some embodiments, a plurality of teams participate in the game match. The win rate change information may be configured for reflecting a change trend, over time, of a win rate of at least one of the plurality of teams.

For example, the win rate change information may be configured for reflecting change trends, over time, of win rates of all of the plurality of teams. For example, eight teams participate in the game match, and the win rate change information may reflect change trends, over time, of win rates of all the eight teams.

For example, the win rate change information may be configured for reflecting change trends, over time, of win rates of some of the plurality of teams. For example, eight teams participate in the game match, and the win rate change information may reflect change trends, over time, of win rates of two of the eight teams.

In some embodiments, two teams participate in the game match. The win rate change information may be configured for reflecting change trends, over time, of win rates of the two teams.

In some embodiments, the client synchronously displays the win rate change information and the at least one event identifier in the process of playing back the video footage of the game match. That is, the video playback interface displays the win rate change information and the at least one event identifier while playing back the video footage of the game match.

In some embodiments, the win rate change information includes a win rate change curve, and the win rate change curve is a curve configured for reflecting the change trend, over time, of the win rate. For example, the win rate change curve is a curve configured for reflecting that the win rate of the at least one team changes over time of the game match, that is, the win rate change curve is updated in real time with the progress of the game match.

The win rate change curve is only a form of the win rate change information. The form of the win rate change information may alternatively be implemented as at least one of the following: a table (for example, different columns in the table correspond to different time and different teams), a histogram (for example, a horizontal axis of the histogram represents time, a vertical axis represents a win rate, and different columns represent different teams), a pie chart (for example, different parts of the pie chart may correspond to win rates of different teams), and a fold line. In the following embodiment, the win rate change information being a win rate change curve is used as an example for description only.

In some embodiments, the video playback interface is a live stream interface, and the game match is a game match that is currently being played. In this case, the win rate change curve is a curve changing with time, so as to reflect real-time changes of the win rate.

In some embodiments, the win rate change curve is configured for reflecting a change trend, over time, of a win rate of a particular team participating in the game match. Each point in the win rate change curve may correspond to a win rate value. In this case, each team participating in the game match may correspond to a win rate change curve.

In some embodiments, the win rate change curve is configured for reflecting a change trend, over time, of win rates of two teams participating in the game match. Each point in the win rate change curve may correspond to two win rate values, and the two win rate values correspond to the two teams. For example, a quantity of teams participating in the game match is 2, and a sum of win rates of the teams is 1, so that a win rate change curve may be used to reflect change trends, over time, of the win rates of the two teams.

In some embodiments, the win rate change curve and an event identifier respectively corresponding to at least one sudden change point in the win rate change curve are displayed on the video playback interface. Each sudden change point is a position point, at which the change in the win rate of the at least one team satisfies a first condition, in the win rate change curve. In some embodiments, the at least one event identifier is in one-to-one correspondence with the at least one sudden change point.

The first condition is configured for determining whether a position point is a sudden change point, and may be set based on a change degree of the win rate. For example, the first condition is that the change in the win rate of the at least one team within a first time range corresponding to the position point is greater than a first threshold. Duration of the first time range and the first threshold may be set by technical personnel as required. For example, the duration of the first time range may be 10 seconds, 30 seconds, 1 minute, or the like, and the first threshold may be 5%, 10%, or the like. This is not limited by the embodiments disclosed this application. A time point corresponding to the position point may be at a start position, a middle position, or an end position of the first time range. This is not limited by the embodiments disclosed this application either. For example, if a win rate at a position point changes by 5% within 5 seconds of a non-end position of a time point corresponding to the position point, the position point is determined as a sudden change point.

In the foregoing embodiment, the win rate change information is displayed in the form of the win rate change curve, and each event identifier is displayed in a manner of correspondence with each sudden change point in the win rate change curve, so that which events affect win rates can be presented relatively intuitively. This helps to improve convenience of obtaining information.

The event identifier is configured for indicating an event that causes a change in the win rate in the game match, for example, an event that causes a change in the win rate to be greater than the first threshold, that is, an event that occurs at the time point corresponding to the sudden change point.

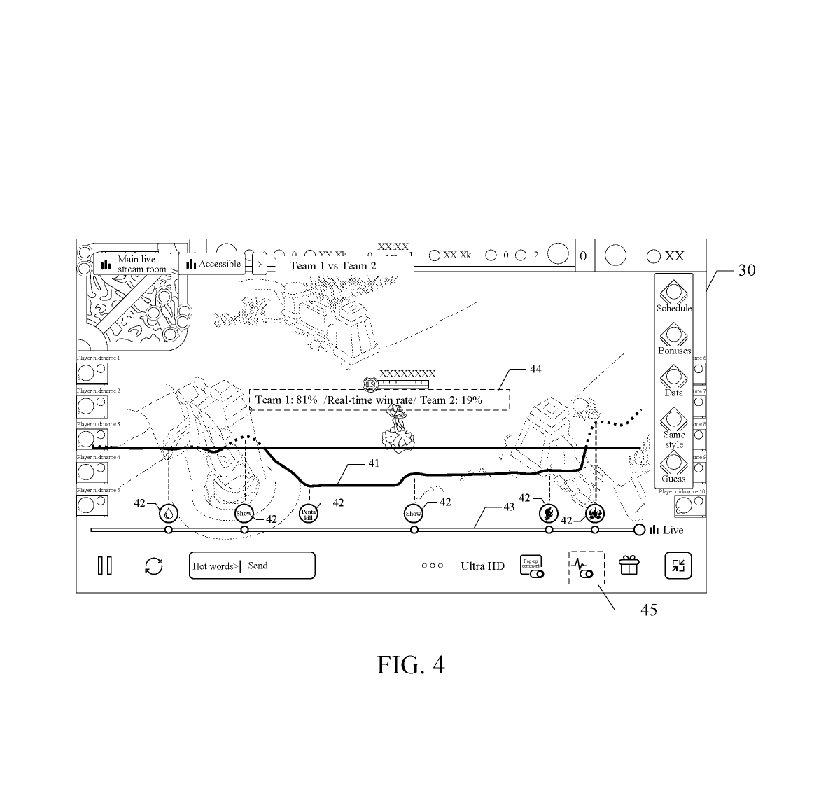

In some embodiments, the event identifier is displayed on a playback progress bar, and the playback progress bar is configured for indicating a playback progress of the video footage. In some embodiments, the playback progress bar may alternatively be configured for adjusting the playback progress of the video footage. For example, FIG. 4 shows a schematic diagram of a win rate change curve and an event identifier according to an embodiment of this application. In this embodiment, the win rate change curve 41 is configured for reflecting change trends, over time, of win rates of two teams, i.e. a team 1 and a team 2. The team 1 and the team 2 are in an adversarial relationship. That is, a win rate of one team increases, and a win rate of the other team decreases. For the win rate change curve 41, the leftmost end corresponds to a start time point of the game match, and the rightmost end corresponds to a current time point of the game match (in a live stream scene). In the win rate change curve 41, a decreasing part reflects that the win rate of the team 2 increases and the win rate of the team 1 decreases, and an increasing part reflects that the win rate of the team 2 decreases and the win rate of the team 1 increases. A win rate, reflected by a dashed line part of the win rate change curve 41, of the team 1 is greater than a win rate of the team 2, and a win rate, reflected by a solid line part, of the team 2 is greater than a win rate of the team 1. An event identifier 42 corresponding to a sudden change point of the win rate change curve 41 is displayed on a playback progress bar 43.

A display style of the event identifier 42 in FIG. 4 is an example. The event identifier 42 may alternatively be displayed in a display style such as a triangle, an arrow symbol, or a numeral. This application does not limit the display style of the event identifier.

In some embodiments, a position, corresponding to the event identifier 42, in the playback progress bar 43 is dotted.

In the foregoing embodiment, the event identifier is displayed on the playback progress bar, so that it is convenient for a user to adjust the playback progress of the video footage based on a prompt of the event identifier, to accurately view the event that causes the change in the win rate, thereby improving the convenience of obtaining information.

In some embodiments, the event identifier is displayed on the win rate change curve, so as to more intuitively indicate the impact of the event on the win rate, thereby improving the convenience of obtaining information. For example, the event identifier is displayed in a manner of one-to-one correspondence with the sudden change point on the win rate change curve.

In some embodiments, for different event identifiers, a style (a color or a rim) of the event identifier may be set differently based on teams in which triggers of events corresponding to the event identifiers belong. For example, in a case that two teams participating in the game match are divided into a red team and a blue team based on colors, if a trigger person of an event belongs to the blue team, an event identifier corresponding to the event is blue, and if a trigger person of an event belongs to the red team, an event identifier corresponding to the event is red.

In some embodiments, the client displays, on the video playback interface in response to an operation for a first position point on the win rate change curve, a video footage at a time stamp corresponding to the first position point, or starts playback, on the video playback interface, from the video footage at the time stamp corresponding to the first position point.

The first position point may be any position point on the win rate change curve. The operation for the first position point may be configured for selecting the first position point. For example, in a case that the terminal device displays the video playback interface through a touch display screen, the operation for the first position point may be a tap or touch and hold operation for the first position point, or an operation of sliding from a second position point (the second position point is different from the first position point) on the win rate change curve to the first position point. This is not limited by the embodiments disclosed in this application. In this embodiment of this application, a pressing operation with duration exceeding set duration may be referred to as a touch and hold operation, and an operation with duration less than the set duration may be referred to as a tap operation. For example, the set duration may be 0.2 seconds, 0.5 seconds, or the like.

In the foregoing embodiment, the win rate change curve may function as the playback progress bar. That is, a user may directly operate the win rate change curve to adjust the playback progress of the video footage. Thus, the user can quickly adjust the playback progress of the video footage based on the change trend of the win rate. This helps to improve accuracy and flexibility of adjusting the playback progress.

In some embodiments, the video playback interface is a live stream interface, and the client displays real-time win rate information on the live stream interface. The real-time win rate information is configured for indicating a win rate, at a current time point, of the at least one team participating in the game match. For example, referring to FIG. 4, real-time win rate information 44 is displayed above the win rate change curve 41, and is configured for indicating real-time win rates of the team 1 and the team 2 that participate in the game match, that is, indicating win rates at a current time point.

In some embodiments, referring to FIG. 4, the video playback interface 30 further displays a win rate display control 45. The win rate display control 45 is configured to control displaying of the win rate change curve 41 (the win rate change information). In a case that the win rate display control 45 is in an activated state, in response to an operation for the win rate display control 45, the client may cancel the displaying of the win rate change curve 41, and the display control 45 is switched to a deactivated state. As shown in FIG. 3, since the win rate display control 45 is in the deactivated state, the client does not display the win rate change curve. In a case that the win rate change curve is not displayed, in response to an operation for the win rate display control 45, the client may display the win rate change curve.

Operation 230: Display, in response to an operation for a first event identifier among the at least one event identifier, event prompt information of the first event identifier.

The event prompt information of the first event identifier is configured for indicating a first event and impact of the first event on the win rate, and the first event is an event indicated by the first event identifier. The first event identifier is any event identifier among the at least one event identifier. The operation for the first event identifier may be configured for selecting the first event identifier. For example, in a case that the terminal device displays the video playback interface through a touch display screen, the operation for the first event identifier may be an operation such as a tap operation, a touch and hold operation, or a slide operation for the first event identifier. This is not limited by the embodiments disclosed in this application.

In some embodiments, the event prompt information of the first event identifier indicates the first event through at least one of the following: a name of the first event, a trigger person of the first event, a name and a team logo of a team in which the trigger person of the first event is, a game screenshot of the first event, and description text of the first event.

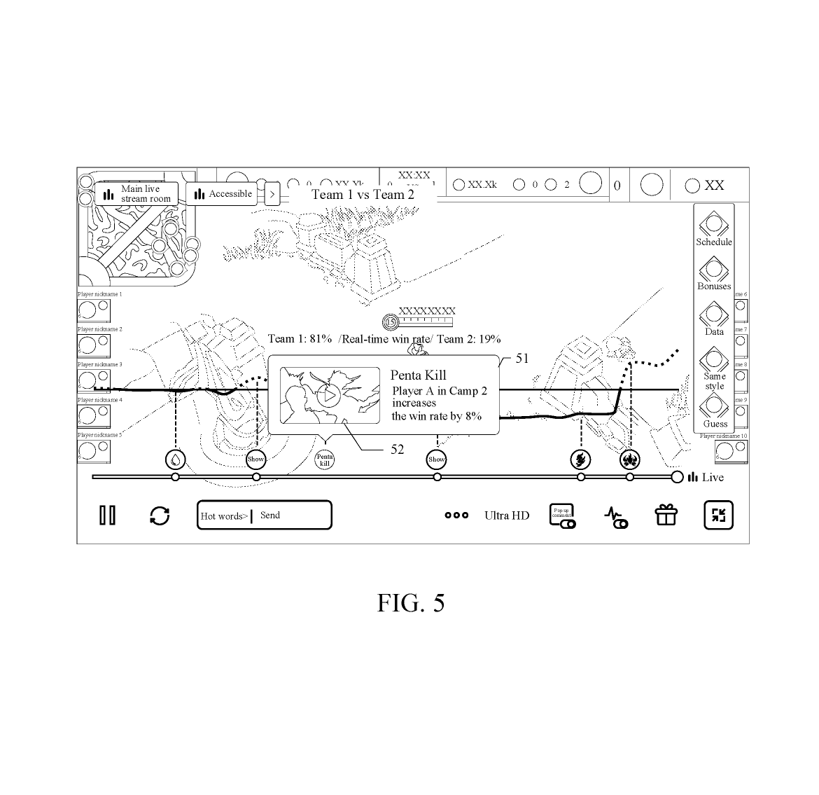

In some embodiments, the event prompt information of the first event identifier may be configured for indicating the impact of the first event on a win rate of the team in which the trigger person of the first event is. For example, FIG. 5 shows a schematic diagram of event prompt information according to an embodiment of this application. The event prompt information 51 includes a game screenshot of a first event, a name of the first event, a trigger person of the first event, and a team in which the trigger person of the first event is, and may be configured for indicating that a player A in a team 2 triggers an event "Penta Kill" to increase a win rate of the team 2 by 8%.

In some embodiments, after displaying the event prompt information of the first event identifier, the client displays, in response to an operation for the event prompt information of the first event identifier, a video clip related to the first event. The operation for the event prompt information is configured for selecting the event prompt information. For example, the operation for the event prompt information may be an operation such as a tap operation, a touch and hold operation, or a slide operation for the event prompt information. This is not limited by the embodiments disclosed in this application. The video clip related to the first event includes a video footage in a process of occurrence of the first event.

For example, referring to FIG. 5, the event prompt information 51 includes a replay control 52. In response to an operation performed by a user on the replay control 52, the client may additionally display a video clip related to a corresponding event, for example, a video clip related to the event "Penta Kill". The video clip is configured for presenting a complete occurrence process of the event.

In the foregoing embodiment, the user may directly operate the event identifier to watch the video clip of the corresponding event, without adjusting the playback progress bar, so that the user can conveniently and accurately watch a video clip of an event that the user is interested in. This helps to improve convenience and accuracy of operations.

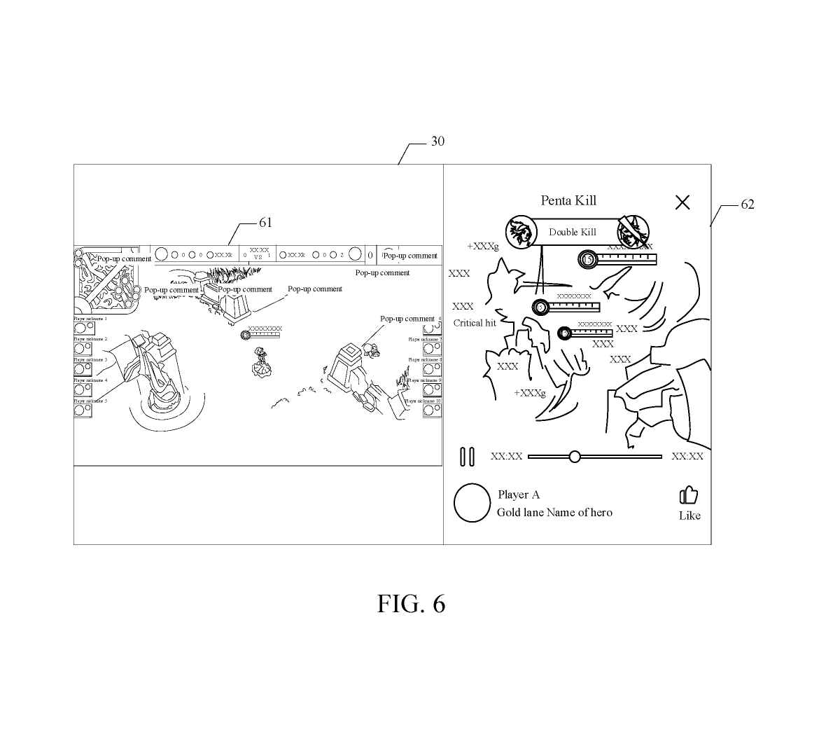

In some embodiments, in response to the operation for the event prompt information corresponding to the first event identifier, the client displays, on the video playback interface in a split-screen manner, the video footage of the game match and the video clip related to the first event. For example, referring to FIG. 6, a video footage 61 of the game match and a video footage 62 related to the event "Penta Kill" are displayed on the video playback interface 30 in a split-screen manner.

In the foregoing embodiment, the video footage of the game match and the video clip related to the first event are displayed in the split-screen manner, so that the video playback interface can simultaneously present the game match at different time points. In a live stream scene, a user cannot miss the latest progress of the game match while replaying historical events in the game match. This helps to enhance viewing experience.

In the technical solution provided in this embodiment of this application, by displaying the win rate change information and the at least one event identifier on the video playback interface on which the video footage of the game match is displayed, the win rate change information can be configured for reflecting the change trend, over time, of the win rate of the at least one team participating in the game match, and the event identifier can be configured for indicating the event that causes the change in the win rate in the game match. In addition, in response to the operation for the first event identifier among the at least one event identifier, the event prompt information corresponding to the first event identifier is displayed. The event prompt information of the first event identifier is configured for indicating the first event and the impact of the first event on the win rate, and the first event is the event indicated by the first event identifier. This enables the video playback interface to not only indicate the change trend of the win rate, but also indicate the event causing the change in the win rate and the impact of the event on the win rate, so that the video playback interface provides match information more comprehensively. This helps to improve comprehensiveness of obtaining information.

In addition, the event causing the change in the win rate can be quickly learned by using the event identifier, and the viewer does not need to view, replay, and analyze a video frame by frame, so that the viewer can quickly learn key information of the game match, thus reducing the difficulty level for obtaining match information and improving the convenience of obtaining information.

In addition, through the foregoing technical solution (the win rate change information and the event identifier), a user can comprehensively learn a development trend of the game match and an event affecting the momentum of the game match, thereby enhancing the viewing experience on the game match.

In some embodiments, a user may be informed, through a bullet comment displayed on the video playback interface, of occurrence, in the game match, of an event that has a relatively significant impact on the win rate. Specifically, the following embodiments will be configured for description:

In some embodiments, a win rate update bullet comment is displayed on the video playback interface in a case that a second event occurs in the game match.

The second event refers to an event in which the change in the win rate of the at least one team satisfies a second condition. The win rate update bullet comment is a bullet comment configured for presenting an impact of the second event on the win rate. The win rate update bullet comment includes win rate update information and a reaction control. The win rate update information is configured for indicating the impact of the second event on the win rate. The reaction control is configured for making a reaction on the second event. Making a reaction refers to a process of expressing an attitude. A bullet comment is also referred to as a "bullet comment" or a "real-time comment". It means that when a video is played back, a comment sent by a user is directly displayed on the video playback interface in a form of a subtitle (including being statically displayed on the interface, or being displayed in a scrolling manner in a direction), and is synchronously updated and displayed with video content. A bullet comment function supports user interaction, to express an attitude, an opinion, and an emotion about content being watched currently, thus increasing user participation.

The second condition is configured for determining whether an event is an event having a relatively significant impact on the win rate, and may be determined based on a change degree of the win rate caused by the event. For example, the second condition may mean that the change in the win rate of the at least one team is greater than a second threshold. For example, the second threshold may be 5%, 10%, or the like. This is not limited by the embodiments disclosed in this application. The second threshold may be the same as or different from the first threshold. For example, when the change in the win rate caused by an event is greater than 10%, the event may be determined as the second event.

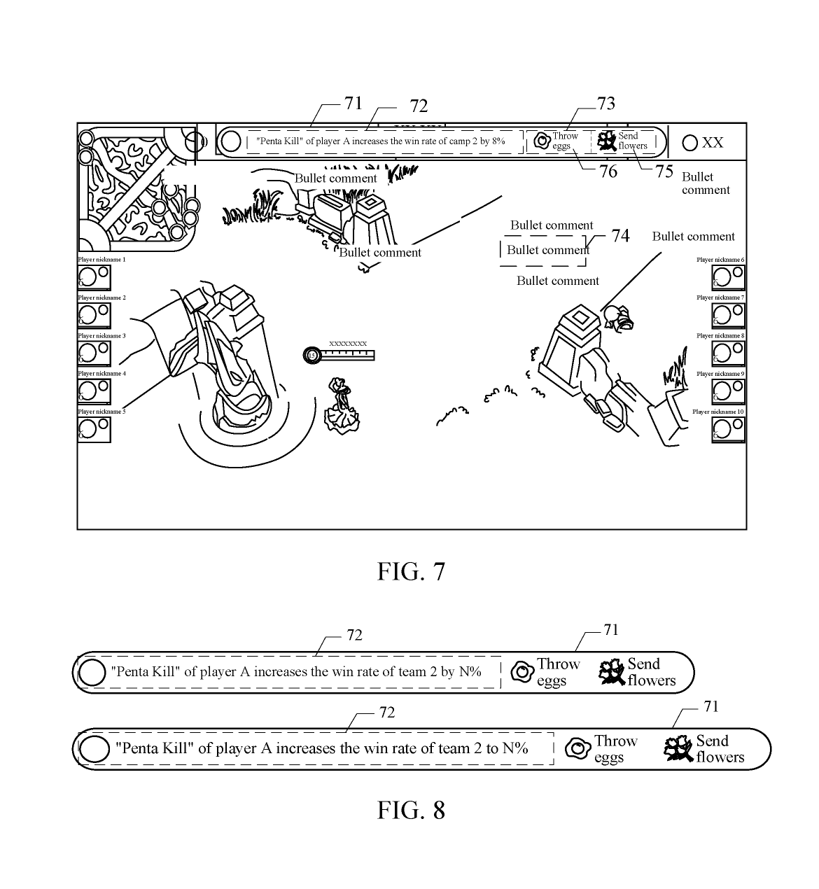

In some embodiments, the win rate update information is configured for indicating an impact of the second event on a win rate of a team in which a trigger person of the second event is. For example, referring to FIG. 7, a win rate update bullet comment 71 is displayed at the top of the video playback interface. The win rate update bullet comment 71 includes win rate update information 72 and a reaction control 73. Another bullet comment 74 besides the win rate update bullet comment 71 is also displayed on the video playback interface. The win rate update information 72 is configured for indicating an impact (the win rate being increased by 8%) of a second event "Penta Kill" on a win rate of a team (the team 2) in which a trigger person (the player A) of the second event is.

In the foregoing embodiment, the win rate update bullet comment is displayed in real time when the second event occurs, so that timeliness of obtaining information about an important event in the game match by a user can be improved, and the user can quickly learn the important event, thereby enhancing viewing experience.

In some embodiments, in a case that the win rate update bullet comment is triggered to be displayed, the win rate update information has different forms. For example, a form of the win rate update information may be determined based on a change degree of the win rate. For example, in a case that the win rate update bullet comment is triggered to be displayed, if the change in the win rate is less than a third threshold, the win rate update information is configured for indicating that the second event increases the win rate of the team in which the trigger person of the second event is to a value. If the change in the win rate is greater than or equal to the third threshold, the win rate update information is configured for indicating that the second event increases the win rate of the team in which the trigger person of the second event is to a value. The third threshold may be set and adjusted based on specific use need. This is not limited by this embodiment of this application.

For example, FIG. 8 shows a schematic diagram of a win rate update bullet comment according to an embodiment of this application. In this embodiment, the win rate update information 72 in the win rate update bullet comment 71 has two forms. One form indicates that a particular event of a particular player is increasing a win rate of a particular team by N%, and the other form indicates that a particular event of a particular player is increasing a win rate of a particular team to N%, where a value range of N is 0 to 100.

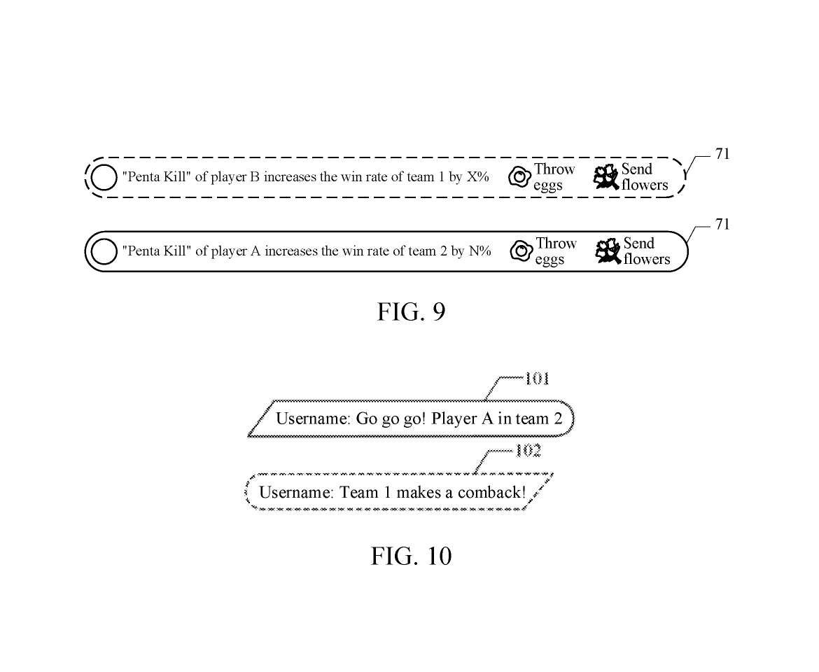

In some embodiments, referring to FIG. 9, for different win rate update bullet comments 71, if trigger persons of second events respectively corresponding to the win rate update bullet comments 71 belong to different teams (respectively the team 1 and the team 2), the two win rate update bullet comments 71 have different display styles (for example, different colors).

In some embodiments, the client displays a reaction bullet comment on the video playback interface in response to an operation for the reaction control, the reaction bullet comment being configured for indicating an attitude about the second event. Reaction information of the second event is configured for indicating an attitude about the second event.

In some embodiments, the reaction information of the second event is configured for reflecting that a user supports or does not support the second event. The reaction information of the second event may alternatively be configured for reflecting that a user supports or does not support the team in which the trigger person of the second event is.

The operation for the reaction control is configured for triggering a function of the reaction control. For example, the operation for the reaction control may be an operation such as a tap operation or a touch and hold operation for the reaction control. This is not limited by embodiments disclosed in this application.

In the foregoing embodiment, after a user performs an operation on the reaction control, the reaction information of the user is fed back in a form of a bullet comment. This increases fun watching the game match by the user, and helps to improve user viscosity.

In some embodiments, the reaction control includes a first control and a second control. For example, referring to FIG. 7, a reaction control 73 includes a first control 75 and a second control 76. A user may make a reaction, by performing an operation on the first control 75 (e.g. sending flowers), of supporting the second event (e.g. "Penta Kill" of the player A), and may make a reaction, by performing an operation on the second control 76 (e.g. throwing eggs), of not supporting the second event.

In some embodiments, the client displays a first reaction bullet comment on the video playback interface in response to an operation for the first control. The first reaction bullet comment is configured for indicating supporting on a first team participating in the game match, and the first team is the team in which the trigger person of the second event is.

In some embodiments, the client displays a second reaction bullet comment on the video playback interface in response to an operation for the second control. The second reaction bullet comment is configured for indicating supporting on a second team participating in the game match, and the second team is different from the first team.

In some embodiments, the first reaction bullet comment moves in a first direction. The second reaction bullet comment moves in a second direction. The first direction is opposite to the second direction.

For example, in response to the operation for the first control 75 in FIG. 7, a first reaction bullet comment 101 shown in FIG. 10 is displayed. The first reaction bullet comment 101 may be configured for reflecting that the user supports the first team (that is, the team 2 in which the player A triggering "Penta Kill" is). Alternatively, in response to the operation for the second control 76 in FIG. 7, a second reaction bullet comment 102 shown in FIG. 10 is displayed. The second reaction bullet comment 102 may be configured for reflecting that the user supports the second team (that is, the team 1).

In the foregoing embodiment, the user can make a quick reaction, by performing an operation, such as a tap operation, on different regions of the reaction control, whether to support the team in which the trigger person of the second event is. Therefore, in the process of watching the game match, the user can make a reaction in real time on a supportive team. This helps to arouse the interest of the user in interaction, thereby increasing a conversion rate of the target application program.

In some embodiments, the client displays, on the live stream interface in response to an operation performed by a first user on the first control, a third reaction bullet comment moving in a first direction and a fourth reaction bullet comment moving in a second direction; and displays, when the third reaction bullet comment and the fourth reaction bullet comment are in contact, an animation effect of collision between the bullet comments.

The first direction is opposite to the second direction. The third reaction bullet comment is configured for reflecting that the first user supports the first team, and the fourth reaction bullet comment is configured for reflecting that a second user supports the second team. The third reaction bullet comment is a reaction bullet comment triggered by the first user through the first control. The fourth reaction bullet comment is a reaction bullet comment triggered by the second user through the second control. The third reaction bullet comment and the fourth reaction bullet comment may be triggered at the same time. The fourth reaction bullet comment may alternatively be triggered before the third reaction bullet comment is triggered, but is delayed being displayed when the third reaction bullet comment is triggered. The third reaction bullet comment and the fourth reaction bullet comment may be matched in different manners by the client.

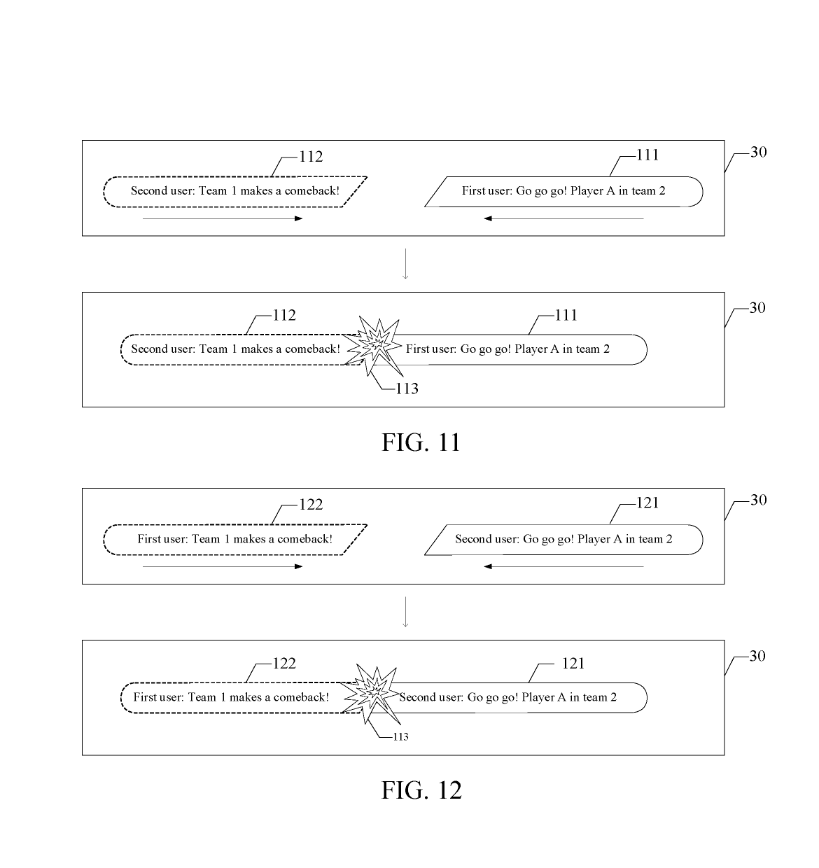

For example, in response to the operation performed by the first user on the first control 75 in FIG. 7, as shown in FIG. 11, a third reaction bullet comment 111 moving from the right side to the left side of the video playback interface 30 and a fourth reaction bullet comment 112 moving from the left side to the right side of the video playback interface 30 are displayed. When the third reaction bullet comment 111 and the fourth reaction bullet comment 112 are in contact, an animation effect 113 of collision between the bullet comments is displayed.

In some embodiments, in response to an operation performed by a first user on the second control, a fifth reaction bullet comment moving in the first direction and a sixth reaction bullet comment moving in the second direction are displayed on the video playback interface; and when the fifth reaction bullet comment and the sixth reaction bullet comment are in contact, an animation effect of collision between the bullet comments is displayed.

A second user is different from the first user. The fifth reaction bullet comment is configured for reflecting that the second user supports the first team. The sixth reaction bullet comment is configured for reflecting that the first user supports the second team. The fifth reaction bullet comment is a reaction bullet comment triggered by the second user through the first control, and the sixth reaction bullet comment is a reaction bullet comment triggered by the first user through the second control. The fifth reaction bullet comment and the sixth reaction bullet comment may be matched in different manners by the client.

For example, in response to the operation performed by the first user on the second control 76 in FIG. 7, as shown in FIG. 12, a fifth reaction bullet comment 121 moving from the left side to the right side of the video playback interface and a sixth reaction bullet comment 122 moving from the right side to the left side of the video playback interface are displayed. When the fifth reaction bullet comment 121 and the sixth reaction bullet comment 122 are in contact, an animation effect 113 of collision between the bullet comments is displayed.

In the foregoing embodiment, by displaying the reaction bullet comments when different users support different teams and the effect of collision between these bullet comments, when the second event occurs, interactions between the users in different teams are supported, thereby enhancing an interaction experience of the users in the process of watching the game match. In addition, when a user feels and participates in an interaction of an important event, flexibility and diversity of the interaction are improved. This helps to arouse the interest of the user in interaction, and further helps to increase the conversion rate of the target application program.

In some embodiments, the reaction bullet comments configured for supporting different teams have different display styles. That is, the first reaction bullet comment and the second reaction bullet comment have different display styles. The third reaction bullet comment and the fourth reaction bullet comment have different display styles. The fifth reaction bullet comment and the sixth reaction bullet comment have different display styles. The different display styles of the bullet comments may be different colors (for example, red and blue colors).

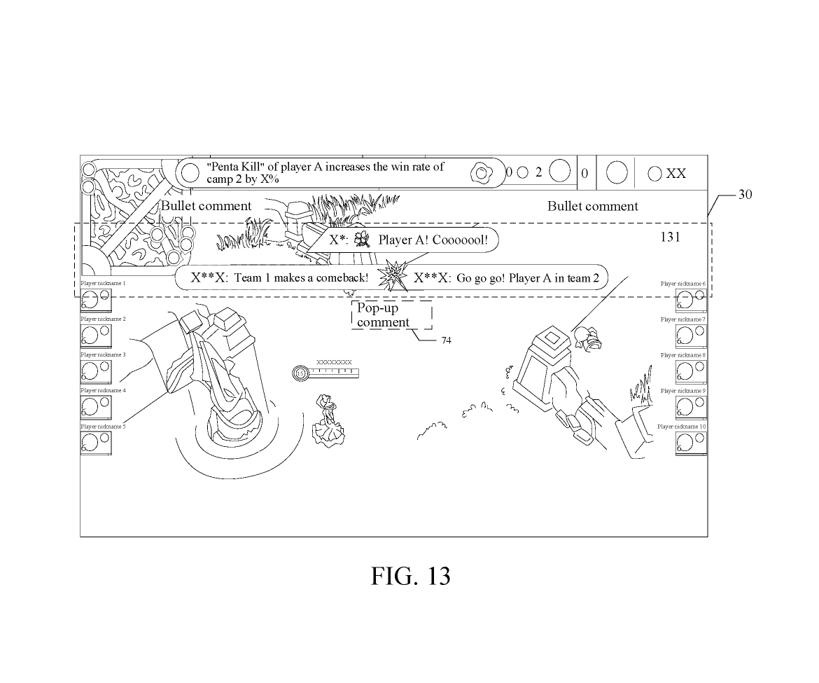

In some embodiments, referring to FIG. 13, the reaction bullet comments are displayed in a set region 131 of the video playback interface 30. Only the reaction bullet comments are displayed in the set region 131, and other bullet comments 74 except the reaction bullet comments are not displayed. In some embodiments, the set region 131 may be implemented as a region occupied by two rows of bullet comment tracks. The bullet comment tracks are configured for displaying the bullet comments, for example, guiding the bullet comments to roll.

In some embodiments, the third reaction bullet comment and the fourth reaction bullet comment are used as an example. In a case that the third reaction bullet comment is determined to be displayed in a first bullet comment track of the two rows of bullet comment tracks, if the fourth reaction bullet comment does not exist in the first bullet comment track, the third reaction bullet comment is switched to be displayed in a second bullet comment track of the two rows of bullet comment tracks, or the third reaction bullet comment is displayed in a delayed manner until the fourth reaction bullet comment appears in the first bullet comment track. The second bullet comment track is different from the first bullet comment track.

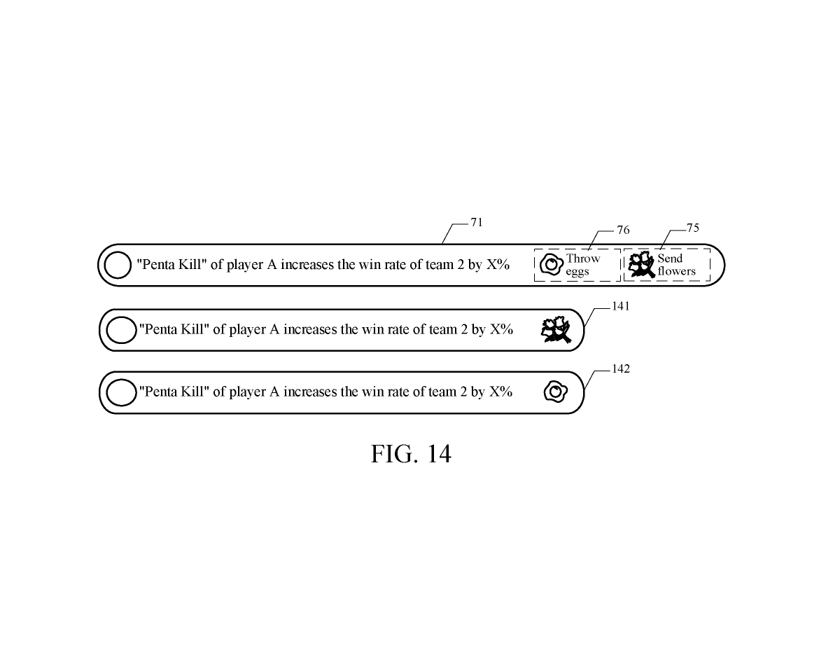

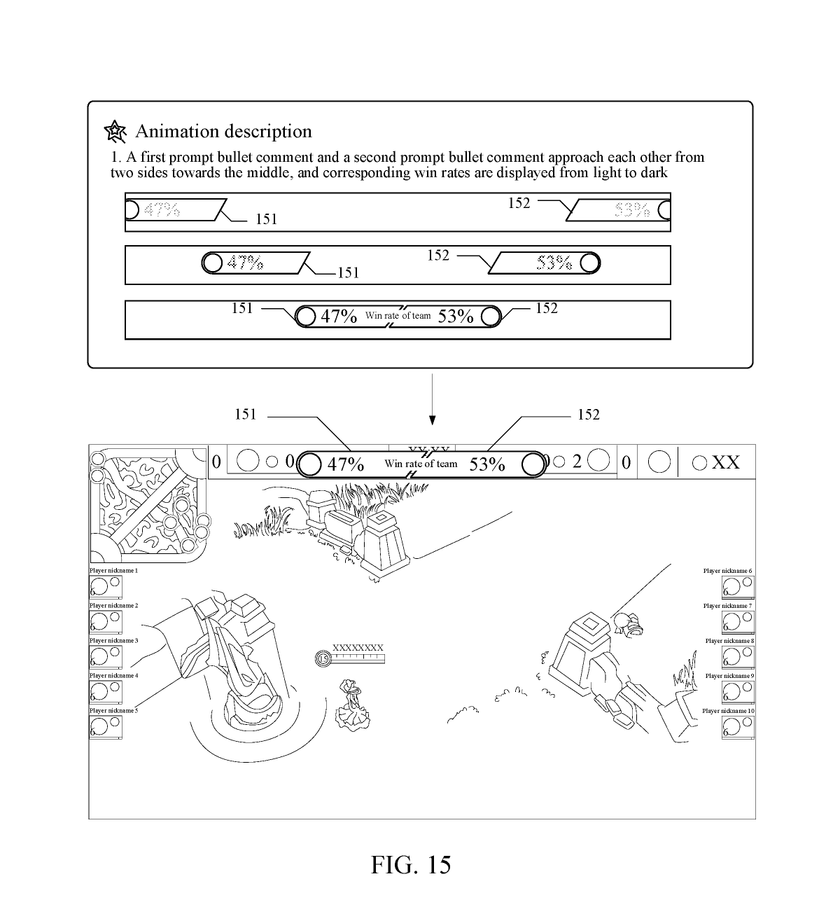

In some embodiments, as shown in FIG. 14, in response to the operation for the first control 75 in the win rate update bullet comment 71, the win rate update bullet comment 71 is changed and displayed as a first completion bullet comment 141, and the first completion bullet comment 141 is configured for reflecting that a user has completed making a reaction of supporting the second event. In response to the operation for the second control 76 in the win rate update bullet comment 71, the win rate update bullet comment 71 is changed and displayed as a second completion bullet comment 142, and the second completion bullet comment 142 is configured for reflecting that a user has completed making a reaction of not supporting the second event.

In some embodiments, the client displays event prompt information corresponding to the second event in response to an operation for the win rate update information. For example, in response to a tap or touch and hold operation on the win rate update information 72 in FIG. 7, as shown in FIG. 5, event prompt information 51 corresponding to the second event is displayed.

In the foregoing embodiment, after the win rate update bullet comment is displayed, a user can quickly open the event prompt information corresponding to the second event through the win rate update information in the win rate update bullet comment, without searching for an event identifier corresponding to the second event. This helps to improve convenience of operations.

In some embodiments, first prompt information is displayed in response to beginning of the game match. The first prompt information is configured for indicating a win rate respectively corresponding to the at least one team at the beginning of the game match, and the win rate respectively corresponding to the at least one team at the beginning of the game match is determined based on a virtual character respectively selected from the at least one team.

In some embodiments, each team corresponds to a plurality of virtual characters, thus forming a virtual character formation. The win rate respectively corresponding to the at least one teams at the beginning of the game match is determined based on the virtual character formation respectively corresponding to the at least one team.

In some embodiments, the first prompt information is configured for indicating win rates respectively corresponding to two teams participating in the game match at the beginning of the game match. For example, referring to FIG. 15, the first prompt information includes a first prompt bullet comment 151 and a second prompt bullet comment 152. The first prompt bullet comment 151 and the second prompt bullet comment 152 respectively indicate the win rate of one of the two teams. The first prompt bullet comment 151 moves in the first direction, and the second prompt bullet comment 152 moves in the second direction (on the same bullet comment track as the first prompt bullet comment 151). The first prompt bullet comment 151 and the second prompt bullet comment 152 stop moving after being in contact with each other. The first prompt bullet comment 151 and the second prompt bullet comment 152 may have different display styles.

In the foregoing embodiment, when the game match begins, a user is notified of an initial win rate determined based on selection of virtual characters, through the first prompt information. This helps the user to adjust an expectation on a result of the game match, so that the user can learn the match more comprehensively.

In some embodiments, the client displays second prompt information in response to ending of the game match. The second prompt information is configured for indicating, in the game match, an event having a greatest impact on a win rate of a winning team of the game match.

In some embodiments, the second prompt information may be configured for indicating, from the at least one event identifier displayed on the video playback interface when the game match ends, an event identifier corresponding to the event having the greatest impact on the win rate of the winning team of the game match. For example, a border of the event identifier is displayed in bold, and the event identifier is highlighted, to obtain the second prompt information.

In some embodiments, in response to ending of the game match, the client displays second prompt information in a form of a bullet comment on the video playback interface.

In the foregoing embodiment, when the game match ends, a user is notified of the event having the greatest impact on the win rate of the winning team of the game match, through the second prompt information. This can help the user learn a key event the momentum of the game match, thereby facilitating analysis of winning and losing causes of the game match by the user. It helps to lower the difficulty in analyzing the winning and losing causes.

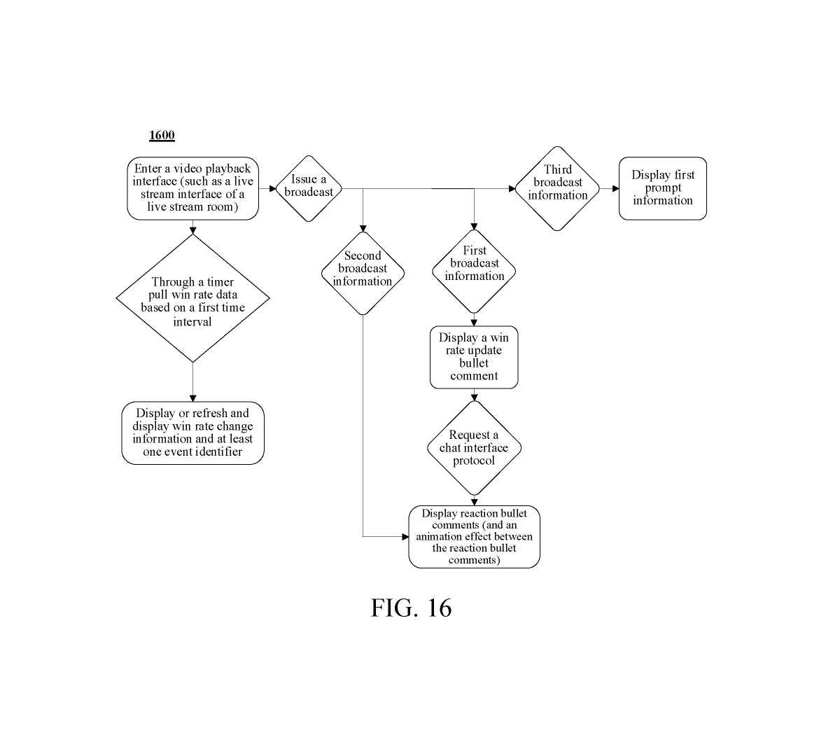

FIG. 16 shows a schematic diagram of an execution logic of an information display method according to an embodiment of this application.

In some embodiments, a client 1600 pulls win rate data based on a first time interval. For example, after entering the video playback interface (for example, a live stream interface of a live stream room), the client 1600 may pull the win rate data from a server based on the first time interval through a timer. The win rate data is configured for indicating the win rate of the at least one team in the game match and the event causing the change in the win rate in the game match.

In some embodiments, the client 1600 displays or refreshes and displays the win rate change information (the win rate change curve) and the at least one event identifier based on the win rate data.

In some embodiments, the client 1600 displays, based on the win rate data, the event prompt information (such as text or a picture) corresponding to the first event identifier and the video clip related to the first event.

In some embodiments, the first time interval is agreed upon by a server protocol. For example, the first time interval is a default time interval of the timer of the client, for example, 1000 milliseconds (ms).

In some embodiments, the client 1600 displays the win rate update bullet comment based on first broadcast information issued by the server. The first broadcast information is configured for indicating the second event and the impact of the second event on the win rate.

In some embodiments, the client 1600 requests a corresponding chat interface protocol from the server based on an operation performed by a user on the reaction control in the win rate update bullet comment. Different chat interface protocols correspond to (different copies of) different types of reaction bullet comments. Different types of reaction bullet comments are configured for reflecting supporting on different teams. For example, in a case that teams participating in the game match are the team 1 and the team 2, the reaction bullet comment configured for reflecting supporting on the team 1 is a first type of reaction bullet comment, and the reaction bullet comment configured for reflecting supporting on the team 2 is a second type of reaction bullet comment.

In some embodiments, the client 1600 displays the reaction bullet comment based on second broadcast information issued by the server. The second broadcast information is configured for instructing the reaction bullet comment to be displayed. In some embodiments, the second broadcast information includes the above chat interface protocol.

In some embodiments, when the game match begins, the client 1600 determines movement directions of different types of reaction bullet comments based on positions respectively corresponding to the two teams participating in the game match in a virtual scene of the game. The foregoing example continues to be used. An MOBA game is used as an example. If a core structure of the team 1 is on the left of a game map, and a core structure of the team 2 is on the right of the game map, it may be determined that a movement direction of the first type of reaction bullet comment is from left to right, and a movement direction of the second type of reaction bullet comment is from right to left.

In some embodiments, the client 1600 determines a type of a to-be-displayed reaction bullet comment based on the operation performed by the user on the reaction control in the win rate update bullet comment, thus determining a direction of the to-be-displayed reaction bullet comment.

In some embodiments, after receiving the second broadcast information issued by the server, the client 1600 determines whether a reaction bullet comment is displayed in a first movement track of the set region on the video playback interface. If no reaction bullet comment is displayed in the first movement track, the reaction bullet comment corresponding to the second broadcast information is directly displayed in the first movement track (in the following embodiment, the reaction bullet comment is referred to as a reaction bullet comment that is being processed). If a reaction bullet comment is displayed in the first movement track, the reaction bullet comment that is being processed is queued up in the first movement track and waits to be displayed. The reaction bullet comment that is being processed may be displayed behind a reaction bullet comment that moves in the same direction. Alternatively, in a case that it is waited until no reaction bullet comment is displayed in the first movement track, the reaction bullet comment that is being processed is displayed in the first movement track. Alternatively, in a case that it is waited until a reaction bullet comment that moves in an opposite direction is to be displayed in the first movement track, the reaction bullet comment that is being processed and the reaction bullet comment that moves in the opposite direction are simultaneously displayed in the first movement track, and an animation effect after the reaction bullet comments collide with each other is displayed. In some other embodiments, if a reaction bullet comment is displayed in the first movement track, the reaction bullet comment that is being processed is switched to a second movement track for displaying. The first movement track and the second movement track are any two different movement tracks in the set region. The movement tracks in this embodiment of this application are the foregoing bullet comment track.

In some embodiments, the client 1600 displays the first prompt information based on third broadcast information issued by the server. The third broadcast information is configured for indicating the win rate of the at least one team at the beginning of the game match.

In some embodiments, the client 1600 queries for a configuration item of a management end based on fourth broadcast information issued by the server. The fourth broadcast information is configured for indicating configuration of a change function of the client. The configuration item of the management end is configured for configuring a function of the client. The configuration item of the management end includes at least one of the following: a win rate prediction toggle, a win rate prediction control curve toggle, a win rate prediction master toggle, a live stream replay toggle, a dot marking toggle, a highlight video on-demand toggle, and a max replay duration.

The win rate prediction toggle may be configured for controlling displaying of the win rate update bullet comment. After the win rate prediction toggle is disabled, the client 1600 no longer displays the win rate update bullet comment.

The win rate prediction control curve toggle may be configured for controlling displaying of the win rate change curve and the win rate display control. After the win rate prediction control curve toggle is disabled, the client 1600 no longer displays the win rate change curve and the win rate display control.

The win rate prediction master toggle may be configured for controlling all functions related to win rate prediction in this embodiment of this application. After the win rate prediction master toggle is disabled, the client 1600 no longer displays the win rate change curve, the win rate update bullet comment, the event prompt information, and the like.

The live stream replay toggle may be configured for controlling a live stream replay function. After the live stream replay toggle is disabled, the client 1600 cannot adjust the playback progress thorough the playback progress bar.

The dot marking toggle may be configured for controlling a dot marking function of the playback progress bar. After the dot marking toggle is disabled, no dot is marked on the playback progress bar.

The highlight video on-demand toggle may be configured for controlling displaying of the video clip related to the event. After the highlight video on-demand toggle is disabled, the client 1600 no longer displays the video clip in response to the operation for the event prompt information.

The max replay duration is configured for controlling maximum replay duration during live streaming.

By reading the fourth broadcast information of the server and cooperatively querying for the configuration of the management end, related functions of the client may be disabled or enabled, so as to control a grayscale and a full runout of each function when a new version of the client goes online.

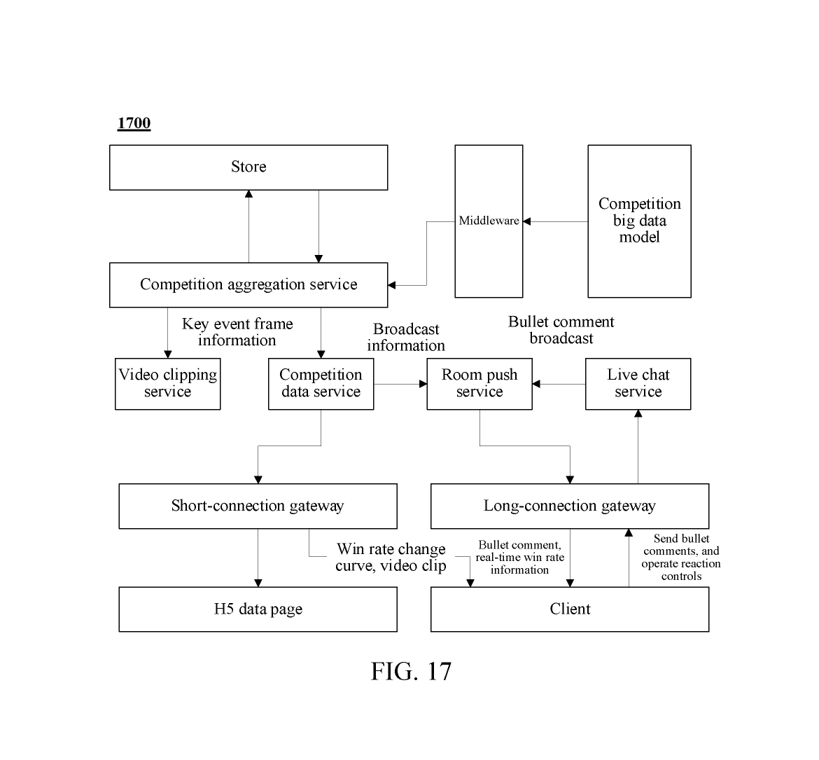

FIG. 17 shows a schematic diagram of a logic of a service side of an information display method according to an embodiment of this application. Operations in the following embodiment are executed by a server, for example, the server of the target application program.

In some embodiments, after a game match begins, a server 1700 predicts, in real time through a big data model and based on video streams of the game match, win rates of teams participating in the game match, and provides key event frame information. For example, the server 1700 may predict the win rates in real time based on the video streams of the game match through a competition big data model. The competition big data model is a big data model obtained through training for the game match. In some embodiments, the predicted win rates may be transmitted to a competition data aggregation service in a form of a message queue.

In some embodiments, the server 1700 aggregates real-time competition data such as real-time win rates and key event frame information through the competition data aggregation service, and records and stores the data.

In some embodiments, the server 1700 generates, based on a notification of the competition data aggregation service and the key event frame information by using a video clipping service, a video clip related to an event.

In some embodiments, the server 1700 pushes broadcast information (such as the first broadcast information, the second broadcast information, the third broadcast information, or the fourth broadcast information) to a client by using a competition data service and a room push service. The competition data service is configured for providing interfaces of various competition data (data such as matches, players, hero, outfits, and economy), and the room push service is configured for pushing the broadcast information.

In some embodiments, by using a live chat service and a room push service, in a case that a user sends a bullet comment or a user performs an operation on a win rate update bullet comment, the server 1700 broadcasts the bullet comment (for example, a reaction bullet comment or the bullet comment directly sent by the user) corresponding to the user.

In some embodiments, different data is transmitted through different gateways. For example, data related to the win rate change curve and the video clip is transmitted through a short-connection gateway, and data related to bullet comments and real-time win rate information is transmitted through a long-connection gateway.

In some embodiments, the server 1700 provides various competition data (including the foregoing win rate data) to an H5 (hypertext markup language 5) data page, so that a user can query for related information of the game match on the H5 page. In some embodiments, the H5 data page and the video playback interface are displayed on a user interface of the target application program together.

In some embodiments, according to the technical solutions provided in this embodiment of this application, indexes such as a quantity of visitors watching the game, a viewer retention count, watch time, and a bullet comment interaction count can be increased for the target application program. The method can provide better and more professional game watching experience for a user, so that the user can learn a winning situation of the match more comprehensively, and can feel and participate in interactions that lead to a winning decision, thereby achieving at least the following beneficial effects:

1. Real-time data analysis: the win rate change information can enable a user to learn about winning probabilities of teams by using real-time data, so that the user can learn about a trend of the game match posture more comprehensively.

2. Setting of suspense: since the situation of the game match continuously changes, a change in the win rate change information adds suspense to the watching process, thus bringing a more stimulating and nervous watching experience to a user.

3. Psychological preparation: a user can get mentally prepared in advance by using the win rate change information, and adjust an expectation on a result of the game match. It helps to alleviate a possible attitude of disappointment.

4. Data visualization: the win rate change information is presented in an intuitive chart form, so that a user can learn about the situation of the game match at a glance, thereby bringing convenience and fun to viewers.

5. Generation of social interactions: a user can further participate in discussion of the game match by using the win rate change information and the event identifier. It helps to increase social interactions.

The following describes an apparatus embodiment which can be configured to perform the method embodiment of this application. For details not disclosed in the apparatus embodiments of this application, refer to the method embodiments of this application.

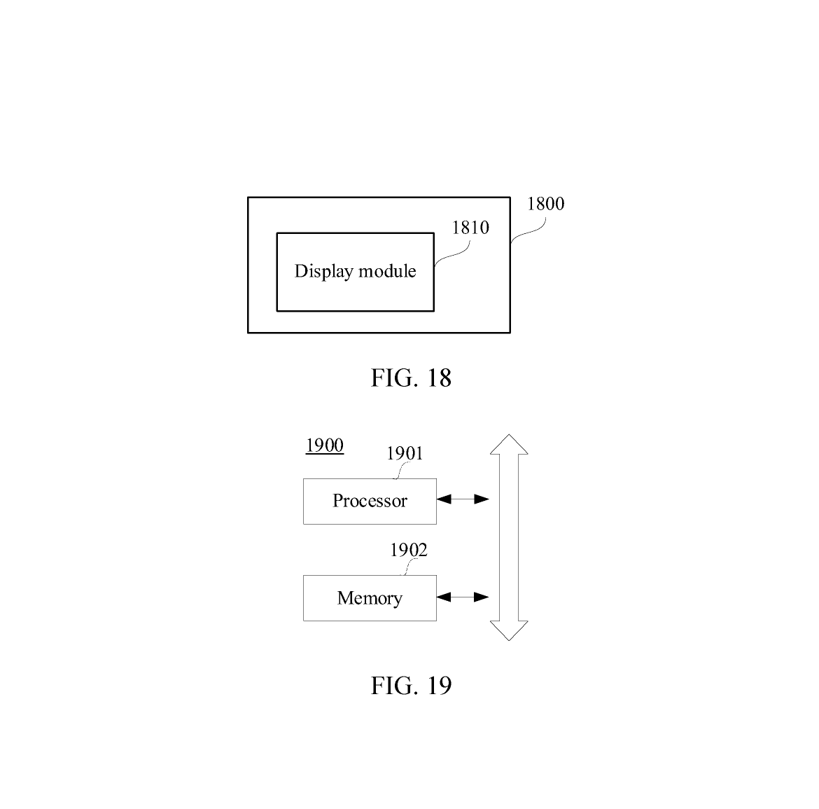

FIG. 18 shows a block diagram of an information display apparatus according to an embodiment of this application. The apparatus has a function of implementing the above method. The function may be implemented by hardware or may be implemented by hardware performing corresponding software. The apparatus may be a terminal device, or may be configured in the terminal device. The apparatus 1800 may include: a display module 1810.

The display module 1810 is configured to display a video footage of a game match on a video playback interface.

The display module 1810 is further configured to display win rate change information and at least one event identifier on the video playback interface, the win rate change information being configured for reflecting a change trend, over time, of a win rate of at least one team participating in the game match, and the event identifier being configured for indicating an event that causes a change in the win rate in the game match.

The display module 1810 is further configured to display, in response to an operation for a first event identifier among the at least one event identifier, event prompt information of the first event identifier, the event prompt information of the first event identifier being configured for indicating a first event and an impact of the first event on the win rate, and the first event being an event indicated by the first event identifier.

In some embodiments, the win rate change information includes a win rate change curve, and the win rate change curve is a curve configured for reflecting the change trend, over time, of the win rate.

The display module 1810 is configured to display, on the video playback interface, the win rate change curve and an event identifier respectively corresponding to at least one sudden change point in the win rate change curve, the sudden change point referring to a position point, at which the change in the win rate satisfies a first condition, in the win rate change curve.

In some embodiments, the event identifier is displayed on a playback progress bar, and the playback progress bar is configured for indicating a playback progress of the video footage; alternatively, the event identifier is displayed on the win rate change curve.

In some embodiments, the display module 1810 is configured to: display, on the video playback interface in response to an operation for a first position point on the win rate change curve, a video footage at a time stamp corresponding to the first position point, or start playback, on the video playback interface, from the video footage at the time stamp corresponding to the first position point.

In some embodiments, the display module 1810 is configured to display, in response to an operation for the event prompt information of the first event identifier, a video clip related to the first event.

In some embodiments, the display module 1810 is configured to display, on the video playback interface in a split-screen manner, the video footage of the game match and the video clip related to the first event.

In some embodiments, the display module 1810 is further configured to display a win rate update bullet comment on the video playback interface in a case that a second event occurs in the game match, the second event referring to an event in which the change in the win rate satisfies a second condition, the win rate update bullet comment including win rate update information and a reaction control, the win rate update information being configured for indicating an impact of the second event on the win rate, and the reaction control being configured for making a reaction on the second event.

In some embodiments, the display module 1810 is further configured to display a reaction bullet comment on the video playback interface in response to an operation for the reaction control, the reaction bullet comment being configured for indicating an attitude about the second event.

In some embodiments, the reaction control includes a first control and a second control.

The display module 1810 is configured to: display a first reaction bullet comment on the video playback interface in response to an operation for the first control; alternatively, display a second reaction bullet comment on the video playback interface in response to an operation for the second control; the first reaction bullet comment being configured for indicating supporting on a first team participating in the game match, the second reaction bullet comment being configured for indicating supporting on a second team participating in the game match, the first team being a team in which a trigger person of the second event is, and the second team being different from the first team.

In some embodiments, the reaction control includes a first control and a second control.

The display module 1810 is configured to: display, on the video playback interface in response to an operation performed by a first user on the first control, a third reaction bullet comment moving in a first direction and a fourth reaction bullet comment moving in a second direction; and display, when the third reaction bullet comment and the fourth reaction bullet comment are in contact, an animation effect of collision between the bullet comments; alternatively, display, on the video playback interface in response to an operation performed by the first user on the second control, a fifth reaction bullet comment moving in the first direction and a sixth reaction bullet comment moving in the second direction; and display, when the fifth reaction bullet comment and the sixth reaction bullet comment are in contact, an animation effect of collision between the bullet comments. The first direction is opposite to the second direction. The third reaction bullet comment is configured for reflecting that the first user supports the first team participating in the game match. The first team is a team in which a trigger person of the second event is. The fourth reaction bullet comment is configured for reflecting that a second user supports a second team participating in the game match. The second user is different from the first user. The second team being different from the first team. The fifth reaction bullet comment is configured for reflecting that the second user supports the first team. The sixth reaction bullet comment is configured for reflecting that the first user supports the second team.

In some embodiments, the display module 1810 is further configured to display event prompt information of the second event in response to an operation for the win rate update information.

In some embodiments, the display module 1810 is further configured to display first prompt information in response to beginning of the game match, the first prompt information being configured for indicating a win rate respectively corresponding to the at least one team at the beginning of the game match, and the win rate respectively corresponding to the at least one team at the beginning of the game match being determined based on a virtual character respectively selected from the at least one team.

In some embodiments, the display module 1810 is further configured to display second prompt information in response to ending of the game match, the second prompt information being configured for indicating, in the game match, an event having a greatest impact on a win rate of a winning team of the game match.

In the technical solution provided in this embodiment of this application, by displaying the win rate change information and the at least one event identifier on the video playback interface on which the video footage of the game match is displayed, the win rate change information can be configured for reflecting the change trend, over time, of the win rate of the at least one team participating in the game match, and the event identifier can be configured for indicating the event that causes the change in the win rate in the game match. In addition, in response to the operation for the first event identifier among the at least one event identifier, the event prompt information corresponding to the first event identifier is displayed. The event prompt information of the first event identifier is configured for indicating the first event and the impact of the first event on the win rate, and the first event is the event indicated by the first event identifier. This enables the video playback interface to not only indicate the change trend of the win rate, but also indicate the event causing the change in the win rate and the impact of the event on the win rate, so that the video playback interface provides match information more comprehensively. This helps to improve comprehensiveness of obtaining information. Meanwhile, by using the win rate change information and the event identifier, a viewer can learn a winning situation of the game match more comprehensively. This helps to enhance viewing experience.

In addition, the event causing the change in the win rate can be quickly learned by using the event identifier, and the viewer does not need to view, replay, and analyze a video frame by frame, so that the viewer can quickly learn key information of the game match, thus reducing the difficulty level for obtaining match information and helping to improving the convenience of obtaining information.

When the apparatus provided in the foregoing embodiments implements functions of the apparatus, the division of the foregoing functional modules is merely an example for description. In the practical application, the functions may be assigned to and completed by different functional modules according to the requirements. To be specific, the internal structure of the device is divided into different functional modules, to implement all or some of the functions described above. In addition, the apparatus provided in the foregoing embodiments and the method embodiments fall within the same conception. For details of a specific implementation process of the apparatus, refer to the method embodiments. Details are not described herein again.

FIG. 19 shows a block diagram of a structure of a terminal device according to an embodiment of this application.

Generally, the electronic device 1900 includes: a processor 1901 and a memory 1902.

The processor 1901 may include one or more processing cores, for example, a 4-core processor or an 8-core processor. The processor 1901 may be implemented in at least one hardware form, including digital signal processing (DSP), a field programmable gate array (FPGA), and a programmable logic array (PLA). The processor 1901 may alternatively include a main processor and a coprocessor. The main processor is a processor configured to process data in a wake-up state, and is also referred to as a central processing unit (CPU). The coprocessor is a low power consumption processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an artificial intelligence (AI) processor. The AI processor is configured to process a computing operation related to machine learning.

The memory 1902 may include one or more computer-readable storage mediums. The computer-readable storage medium may be visible and non-transient. The memory 1902 may further include a high-speed random access memory, as well as non-volatile memory, such as one or more disk storage devices and flash storage devices. In some embodiments, the non-transient computer-readable storage medium in the memory 1902 has a computer program stored therein. The computer program is loaded and executed by the processor 1901 to implement the method for controlling a virtual item provided in the foregoing method embodiments.

A person skilled in the art may understand that the structure shown in FIG. 19 constitutes no limitation on the terminal device 1900, and the terminal device may include more or fewer components than those shown in the figure, or a combination of some components, or have a different arrangement of components.

In some embodiments, a computer-readable storage medium is further provided. The storage medium has a computer program stored therein. The computer program, when loaded and executed by a processor, implementing the foregoing information display method.

In one embodiment, the computer-readable storage medium may include: a read-only memory (ROM), a random-access memory (RAM), Solid State Drives (SSDs), or an optical disc. The RAM may include a resistance RAM (ReRAM) and a dynamic RAM (DRAM).

In some embodiments, a computer program product is further provided. The computer program product includes a computer program. The computer program is stored in a computer-readable storage medium. A processor reads and executes the computer program from the computer-readable storage medium, to implement the foregoing information display method.

"Plurality of" mentioned herein means two or more. The term "and/or" describes an association relationship of associated objects, representing that three relationships may exist. For example, A and/or B may represent three situations: A exists alone; A and B exist simultaneously; and B exists alone. The character "/" usually indicates an "or" relationship between associated objects. In addition, the serial numbers of the operations described in this specification merely schematically show a possible execution sequence of the operations. In some other embodiments, the operations may not be performed according to the serial numbers. For example, two operations with different serial numbers may be performed simultaneously, or two operations with different serial numbers may be performed according to a sequence contrary to the sequence shown in the figure. This is not limited by the embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. An information display method, performed by a terminal device and comprising:
displaying a video footage of a game match on a video playback interface;
displaying win rate change information and at least one event identifier on the video playback interface, the win rate change information reflecting a change trend, over time, of a win rate of at least one team participating in the game match, and the event identifier indicating an event associated with a change in the win rate in the game match; and
displaying, in response to an operation for a first event identifier among the at least one event identifier, event prompt information of the first event identifier, the event prompt information of the first event identifier indicating a first event and an impact of the first event on the win rate, and the first event being an event indicated by the first event identifier.

2. The method according to claim 1, wherein the win rate change information comprises a win rate change curve, and the win rate change curve is a curve reflecting the change trend over time, of the win rate; and
the displaying win rate change information and at least one event identifier on the video playback interface comprises:
displaying, on the video playback interface, the win rate change curve and an event identifier respectively corresponding to at least one sudden change point in the win rate change curve, the sudden change point referring to a position point on the win rate change curve, at which the change in the win rate satisfies a first condition.

3. The method according to claim 2, wherein
the event identifier is displayed on a playback progress bar, and the playback progress bar indicates a playback progress of the video footage;
alternatively,
the event identifier is displayed on the win rate change curve.

4. The method according to claim 2, wherein the method further comprises:
displaying, on the video playback interface in response to an operation for a first position point on the win rate change curve, a video footage at a time stamp corresponding to the first position point, or starting playback, on the video playback interface, from the video footage at the time stamp corresponding to the first position point.

5. The method according to claim 1, wherein the method further comprises:
displaying, in response to an operation on the event prompt information of the first event identifier, a video clip related to the first event.

6. The method according to claim 5, wherein the displaying a video clip related to the first event comprises:
displaying, on the video playback interface in a split-screen manner, the video footage of the game match and the video clip related to the first event.

7. The method according to claim 1, wherein the method further comprises:
displaying a win rate update bullet comment on the video playback interface when a second event occurs in the game match, the second event referring to an event in which the change in the win rate satisfies a second condition, the win rate update bullet comment comprising win rate update information and a reaction control, the win rate update information indicating an impact of the second event on the win rate, and the reaction control enabling a reaction on the second event.

8. The method according to claim 7, wherein the method further comprises:
displaying a reaction bullet comment on the video playback interface in response to an operation for the reaction control, the reaction bullet comment indicating an attitude about the second event.

9. The method according to claim 8, wherein the reaction control comprises a first control and a second control; and
the displaying a reaction bullet comment on the video playback interface in response to an operation for the reaction control comprises:
displaying a first reaction bullet comment on the video playback interface in response to an operation for the first control;
alternatively,
displaying a second reaction bullet comment on the video playback interface in response to an operation for the second control;
the first reaction bullet comment indicating supporting for a first team participating in the game match, the second reaction bullet comment indicating supporting on a second team participating in the game match, the first team being a team in which a trigger person of the second event is, and the second team being different from the first team.

10. The method according to claim 8, wherein the reaction control comprises a first control and a second control; and
the displaying a reaction bullet comment on the video playback interface in response to an operation for the reaction control comprises:
displaying, on the video playback interface in response to an operation performed by a first user on the first control, a third reaction bullet comment moving in a first direction and a fourth reaction bullet comment moving in a second direction; and displaying, when the third reaction bullet comment and the fourth reaction bullet comment are in contact, an animation effect of collision between the bullet comments;
alternatively,
displaying, on the video playback interface in response to an operation performed by the first user on the second control, a fifth reaction bullet comment moving in the first direction and a sixth reaction bullet comment moving in the second direction; and displaying, when the fifth reaction bullet comment and the sixth reaction bullet comment are in contact, an animation effect of collision between the bullet comments;
the first direction being opposite to the second direction, the third reaction bullet comment reflecting that the first user supports the first team participating in the game match, the first team being a team in which a trigger person of the second event is, the fourth reaction bullet comment reflecting that a second user supports a second team participating in the game match, the second user being different from the first user, the second team being different from the first team, the fifth reaction bullet comment reflecting that the second user supports the first team, and the sixth reaction bullet comment reflecting that the first user supports the second team.

11. The method according to claim 7, wherein the method further comprises:
displaying event prompt information of the second event in response to an operation on the win rate update information.

12. The method according to claim 1, wherein the method further comprises:
displaying first prompt information in response to beginning of the game match, the first prompt information indicating a win rate respectively corresponding to the at least one team at the beginning of the game match, and the win rate respectively corresponding to the at least one team at the beginning of the game match being determined based on a virtual character respectively selected from the at least one team.

13. The method according to claim 1, wherein the method further comprises:
displaying second prompt information in response to ending of the game match, the second prompt information indicating, in the game match, an event having the greatest impact on a win rate of a winning team of the game match.

14. A terminal device, the terminal device comprising one or more processors and a memory, the memory having a computer program stored therein, and the computer program being loaded and executed by the one or more processors to implement an information display method comprising:
displaying a video footage of a game match on a video playback interface;
displaying win rate change information and at least one event identifier on the video playback interface, the win rate change information reflecting a change trend, over time, of a win rate of at least one team participating in the game match, and the event identifier indicating an event associated with a change in the win rate in the game match; and
displaying, in response to an operation for a first event identifier among the at least one event identifier, event prompt information of the first event identifier, the event prompt information of the first event identifier indicating a first event and an impact of the first event on the win rate, and the first event being an event indicated by the first event identifier.

15. The terminal device according to claim 14, wherein the win rate change information comprises a win rate change curve, and the win rate change curve is a curve reflecting the change trend over time, of the win rate; and
the displaying win rate change information and at least one event identifier on the video playback interface comprises:
displaying, on the video playback interface, the win rate change curve and an event identifier respectively corresponding to at least one sudden change point in the win rate change curve, the sudden change point referring to a position point on the win rate change curve, at which the change in the win rate satisfies a first condition.

16. The terminal device according to claim 15, wherein
the event identifier is displayed on a playback progress bar, and the playback progress bar indicates a playback progress of the video footage;
alternatively,
the event identifier is displayed on the win rate change curve.

17. The terminal device according to claim 15, wherein the information display method further comprises:
displaying, on the video playback interface in response to an operation for a first position point on the win rate change curve, a video footage at a time stamp corresponding to the first position point, or starting playback, on the video playback interface, from the video footage at the time stamp corresponding to the first position point.

18. The information display according to claim 14, wherein the information display method further comprises:
displaying, in response to an operation on the event prompt information of the first event identifier, a video clip related to the first event.

19. A non-transitory computer-readable storage medium, the computer-readable storage medium having a computer program stored therein, and the computer program being loaded and executed by a processor to implement an information display method comprising:
displaying a video footage of a game match on a video playback interface;
displaying win rate change information and at least one event identifier on the video playback interface, the win rate change information reflecting a change trend, over time, of a win rate of at least one team participating in the game match, and the event identifier indicating an event associated with a change in the win rate in the game match; and
displaying, in response to an operation for a first event identifier among the at least one event identifier, event prompt information of the first event identifier, the event prompt information of the first event identifier indicating a first event and an impact of the first event on the win rate, and the first event being an event indicated by the first event identifier.

20. The computer-readable storage medium according to claim 19, wherein the win rate change information comprises a win rate change curve, and the win rate change curve is a curve reflecting the change trend over time, of the win rate; and
the displaying win rate change information and at least one event identifier on the video playback interface comprises:
displaying, on the video playback interface, the win rate change curve and an event
identifier respectively corresponding to at least one sudden change point in the win rate change curve, the sudden change point referring to a position point on the win rate change curve, at which the change in the win rate satisfies a first condition.
